(19) United States
(12) Patent Application Publication
(10) Pub. No.: US 2016/0017922 A1
(43) Pub. Date: Jan. 21, 2016

(54) ROLLING BEARING COMPRISING A HOUSING HAVING TWO PARTS AND METHOD FOR MANUFACTURING AND INSTALLING SUCH A BEARING

(71) Applicant: Olivier VERBE, Tours (FR)

(72) Inventor: Olivier VERBE, Tours (FR)

(21) Appl. No.: 14/434,126

(22) PCT Filed: Oct. 10, 2012
(86) PCT No.: PCT/IB2012/002634

§ 371 Date: Apr. 8, 2015

(51) Int. Cl. F16C 33/60; F16C 43/04; F16C 19/06

(52) U.S. Cl. CPC F16C 33/605; F16C 33/60; F16C 19/06; F16C 43/04

(57) ABSTRACT

A rolling bearing comprising an inner ring, an outer ring, and at least one row of rolling elements in a rolling chamber defined between the rings. An annular housing surrounds at least one of the rings comprising at least two separate parts. The housing comprises two distinct parts for retaining the separate parts of the ring. The housing is such as: (a) the first part is provided with an inner axial cylindrical portion for retaining radially the at least two parts of the ring, and (b) the second part is provided with an outer axial cylindrical portion surrounding the inner axial cylindrical portion and a projected portion extending radially outwards.

### CROSS REFERENCE TO RELATED APPLICATIONS

This is a United States National Stage Patent Application claiming the benefit of International Patent Application Number PCT/IB2012/002634 filed on 10 Oct. 2012 (10.10.2012), which is incorporated herein by reference in its entirety.

### FIELD OF THE INVENTION

The invention relates to rolling bearings, particularly to rolling bearings comprising an inner ring and an outer ring with one or more rows of rolling elements, such as balls, between raceways provided in the two rings. This may, for example, the rolling bearings sued in industrial electric motors or in motor vehicle gear boxes. In such applications, the bearings are mainly under radial load, often under a load that is relatively light in relation to the load bearing capacity of the bearings used.

### PRIOR ART

Patent application FR 2 945 090 discloses a rolling bearing comprising an inner ring, an outer ring made in two parts, a housing holding the two parts of the said ring and a row of balls held by a cage. The housing comprises two distinct parts fixed together wherein two radial flanges axially retains the parts of the outer ring and an axial cylindrical portion connected to one of the radial flanges radially retains the parts of said outer ring.

Furthermore the axial cylindrical portion comprises a radial projection extending radially outwards and fixed to one of the radial flanges and a bearing supporting member, such as a motor housing or casing.

Such a rolling bearing guarantees a desired axial clearance or, a predefined axial preload. It can be easily axially positioned, mounted or dismounted on an external element.

However, such a rolling bearing needs an additional component, such as a spacer, to ensure different locations in axial positioning on its supporting member. The assembly possibilities on its supporting member remain limited since some configurations cannot be achieved with such a rolling bearing.

Furthermore, when assembling such a rolling bearing, a slight deformation of the outer surface of the axial cylindrical portion may modify the positioning of the two separate parts of the outer ring. Such a rolling bearing does not prevent solid and liquid pollutants from entering between the flanges and the radial projection.

### OBJECT AND BRIEF SUMMARY OF THE INVENTION

It is therefore a particular object of the present invention to overcome these aforementioned drawbacks by providing a rolling bearing of simple design with a reduced number of components, that is easy to assemble, economical, able to operate for a long time in both an effective and an economic manner, and ensures unlimited possibilities of positioning on its supporting member.

Another object of the invention is to provide a rolling bearing in which the positioning of the half rings is not sensitive to the deformation of the housing.

The invention concerns a rolling bearing comprising an inner ring, an outer ring, at least one row of rolling elements in a rolling chamber defined between the rings, and an annular housing surrounding at least one of the rings, said ring comprising at least two separate parts. The housing comprises two distinct parts for retaining the parts of said ring.

According to the invention, the housing is such as the first part is provided with an inner axial cylindrical portion for retaining radially the at least two parts of said ring, and the second part is provided with an outer axial cylindrical portion surrounding said inner axial cylindrical portion and a projected portion extending radially outwards.

Thanks to this invention, the projected portion is axially in contact with at least one bearing supporting member, substantially in a plane parallel to the radial symmetry plane of the rolling elements. The rolling bearing can be positioned at any axial location on its supporting member.

The two separate parts of one ring are still radially maintained by the first part of the housing while the second part of the housing has a first function to maintain the first part of the housing and the two parts of the ring, a second function to precisely position the rolling bearing on its supporting member and eventually a third function to fix the rolling bearing to its supporting member.

The projected portion of the housing second part can be realized at any axial location of the outer axial cylindrical portion of the said housing second part. Therefore the axial position of the rolling bearing on its supporting member can be determined depending on the application and the complete assembly wherein the rolling bearing is installed. The rolling bearing axial positioning is not anymore a constraint for the definition of the complete assembly.

According to further aspects of the invention, which are advantageous but not compulsory, such a rolling bearing may incorporate one or several of the following features as long as there is no contradiction:
The rolling elements are balls.
The rolling elements are circumferentially maintained by a cage.
One of the outer or inner ring comprises two separate parts surrounded by the annular housing and the other ring is massive and provided on its exterior cylindrical surface by a toroidal groove forming a raceway for the rolling elements.
The massive ring is manufactured by machining or by pressing a steel blank, which is then ground and optionally lapped at the raceway.
The separate parts of one ring are identical, symmetric with respect to the axial plane of symmetry of the bearing and comprise a toroidal portion forming a raceway for the rolling elements.
The separate parts of one ring are manufactured by cutting and stamping a metal sheet.
The first part of the housing surrounding one ring comprises a radial flange extending radially from the inner cylindrical portion towards the other ring.
The second part of the housing surrounding one ring comprises a radial flange extending radially from the outer cylindrical portion towards the other ring.
At least one of the two separate parts of one ring delimits with the housing a closed space inside which a lubricant and/or electronic elements and/or magnetic elements are located.
Each of the separate parts comprising a closed space wherein lubricant is located also comprises passage means between the closed space wherein the lubricant is located and the rolling chamber wherein the rolling elements are located.
The distinct parts of the housing are manufactured by cutting and stamping a metal sheet. In particular, the projected portion of the housing second part is realized by deformation of the outer cylindrical portion.
The distinct parts of the housing are fixed together by fixing means, such as screws, welds, brazing or glue. Alternatively, it is even possible to fix the two parts together using crimping, bonding, riveting, and/or snap-fastening.
The projected portion is a radial flange.
The projected portion is provided with a radial portion which is extending radially outwards from the outer cylindrical portion, and an axial portion which is extending axially inwards or outwards from the said radial portion.
The projected portion has a half-circle shape.
The projected portion is provided with at least one curved portion.
The projected portion has an axially inwardly curved portion which is extending from the outer cylindrical portion, and a radial portion which is extending radially outwards from the said curved portion.
The projected portion has a radial portion which is extending radially outwards from the outer cylindrical portion, and an axially outwardly curved portion which is extending from the said radial portion.
The axial position of the surface contact between the projected portion and the member is comprised between 0 and 50% of the total axial length of the rolling bearing.

According to another aspect of the invention, it is provided an assembly comprising at least one member against which a rolling bearing according to any of the preceding features is in abutment. Advantageously, the projected portion is fixed on the rolling bearing supporting member by a fixing element, such as screws, welds, brazing or glue. Alternatively, it is even possible to fix them together using crimping, bonding, riveting, and/or snap-fastening.

According to another aspect of the present invention, it is proposed a method of manufacturing and installing an assembly comprising such a rolling bearing as disclosed above, comprising the steps of:
Inserting one of the separate parts of one ring in a first part of the housing comprising a radial flange and an inner cylindrical portion,
Inserting one of the other ring and the rolling elements in the first part of the housing,
Inserting the other separate part of the said ring in the first part of the housing,
Fixing the second part of the housing comprising a radial flange and an outer cylindrical portion so as to surround said inner axial cylindrical portion,
Inserting the rolling bearing in a bore of an external member, and
Positioning the projected portion of the housing second part in abutment against the external member.

Advantageously, the method of manufacturing and installing such an assembly also comprises the step of fixing the projected portion of the housing second part on the member.

### BRIEF DESCRIPTION OF THE DRAWINGS

The present invention and its advantages will be better understood by studying the detailed description of specific embodiments given by way of non-limiting examples and illustrated by the appended drawings, wherein:

FIGS. 1a, 1b, and 1c presents sectioned views of variants of a first embodiment of a rolling bearing;

FIG. 2 presents a sectioned view of a second embodiment of the rolling bearing;

FIG. 3 presents a sectioned view of a third embodiment of the rolling bearing; and

FIG. 4 presents a sectioned view of a fourth embodiment of the rolling bearing.

### DETAILED DESCRIPTION OF PARTICULAR EMBODIMENTS

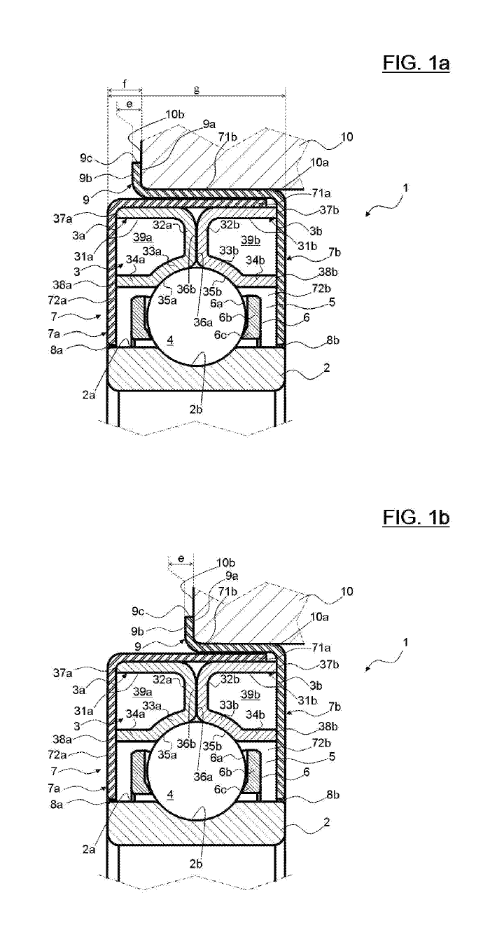

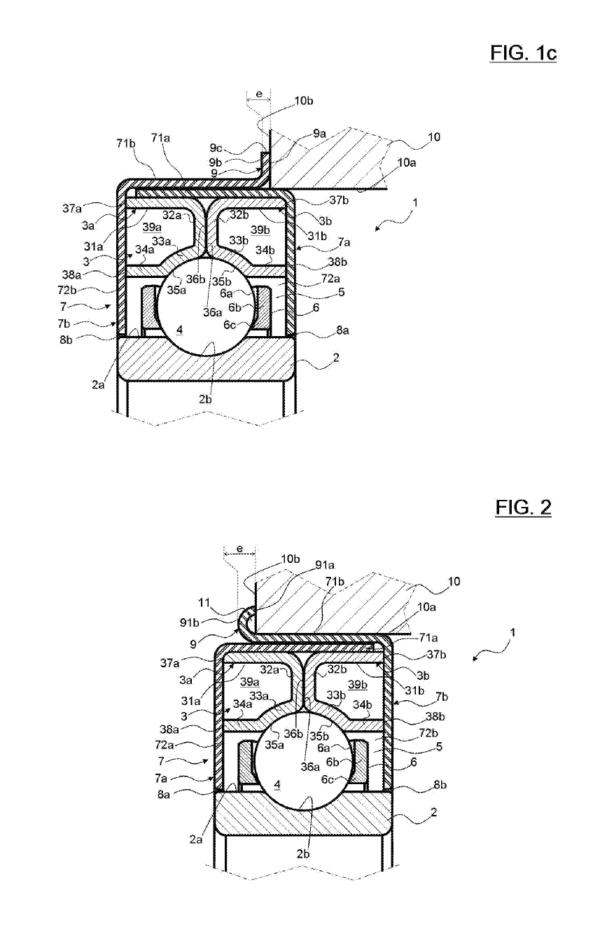

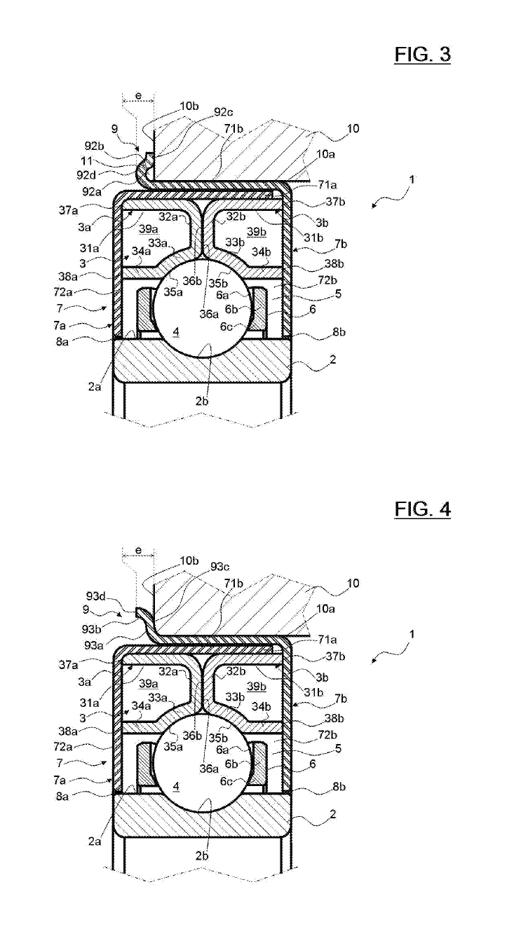

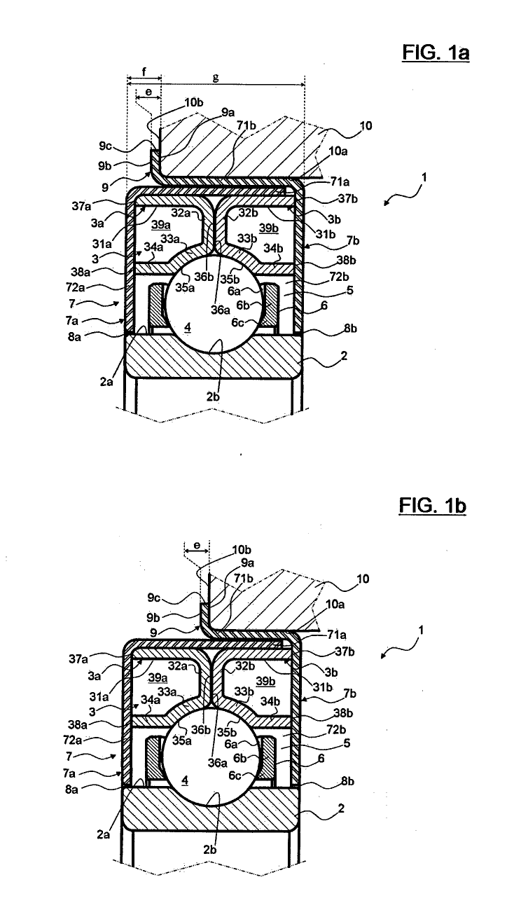

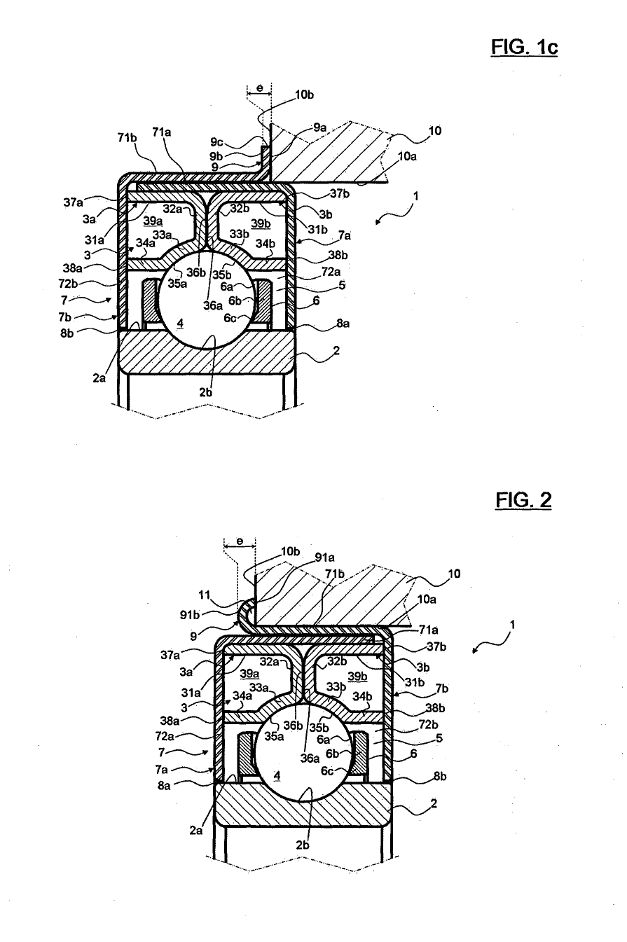

Referring first to FIG. 1a, which illustrates an embodiment of a rolling bearing according to the invention, a rolling bearing 1 comprises an inner ring 2, an outer ring 3, a row of rolling elements 4 consisting, in the example illustrated, of balls, located in a rolling chamber 5 defined between the two rings 2 and 3 and held by a cage 6, and a housing 7 surrounding the outer ring 3.

In this embodiment and the following ones, the terms “axial” and “radial” are defined in relation to the axis of relative rotation of the rings 2 and 3. Then an axial portion is parallel to this axis of rotation and a radial portion is perpendicular to this axis.

The inner ring 2 is massive and has on its outer cylindrical surface 1a a toroidal groove 2b forming a raceway for the rolling elements 4. The radius of curvature of the toroidal groove 2b slightly exceeds the radius of the rolling elements 4.

The cage 6 comprises a plurality of cavities 6a designed to house the rolling elements 4 and keep them uniformly circumferentially spaced. The cavities 6a are advantageously of spherical shape with a diameter slightly exceeding that of the rolling elements 4. The cavities 6a are provided on the radial thickness of the cage 6 having a radial portion 6b radially facing the outer ring 3 and extending radially inwards by a conical portion 6c. The conical portion is located radially facing the inner ring 2 and extends axially towards the rolling elements 4. The radial and conical portions 6b and 6c define the cavities 6a. The conical portion 6c forms a guide portion for the rolling elements 4.

In this embodiment, the outer ring 3 comprises two separate parts 3a and 3b, or half-rings. The half-rings 3a, 3b are identical and symmetric with respect to the axial plane of symmetry of the rolling bearing 1, in order to reduce manufacturing costs. Since the two half-rings are identical in this example, only one of them, having the reference “a” will be described here, it being understood that the identical elements of the other half-ring 3b bear the reference “b” in the figures.

The half-ring 3a of the outer ring 3 comprises an outer axial cylindrical portion 31a, a radial portion 32a, a toroidal portion 33a and an inner axial cylindrical portion 34a. The toroidal portion 33a defines part of a raceway 35a for the rolling elements 4. The radius of curvature of the raceway 35a slightly exceeds than the radius of the rolling elements 4. The toroidal portion 33a extends axially towards the outside of the rolling bearing with the inner axial portion 34a.

The two half-rings 3a, 3b are arranged with the axially internal radial faces 36a, 36b of the radial portions 32a, 32b in axial contact with one another, substantially in the radial symmetry plane of the rolling elements 4.

The housing 7 comprises two distinct annular parts 7a, 7b surrounding the two outer half-rings 3a, 3b so as to hold them firmly together in the radial direction. The first part 7a and the second part 7b of the housing 7 have an L-shaped structure.

The first part 7a comprises an inner axial cylindrical portion 71a surrounding the outer half-rings 3a, 3b and is in contact with the outer surfaces of the axial portions 31a, 31b of the outer half-rings 3a, 3b in order to retain them radially. The first part 7a further comprises a radial flange 72a extending radially from the inner axial cylindrical portion 71a towards the immediate vicinity of the outer cylindrical surface 2a of the inner ring 2, so as to leave a clearance 8a between the free end of the radial flange 72a and the outer cylindrical surface 2a.

The second part 7b comprises an outer axial cylindrical portion 71b surrounding the inner axial cylindrical portion 71a of the first part 7a. The second part 7b further comprises a radial flange 72b extending radially from the outer axial cylindrical portion 71b towards the immediate vicinity of the outer cylindrical surface 2a of the inner ring 2, so as to leave a clearance 8b between the free end of the radial flange 72b and the outer cylindrical surface 2a.

The outer radial faces 37a, 37b which form the outer edges of the outer axial portions 31a, 31b are respectively in contact with the radial flanges 72a, 72b of the parts 7a, 7b of the housing 7, so as to hold the two half-rings 3a, 3b firmly together in the axial direction.

The outer radial faces 38a, 38b which form the outer edges of the inner axial portions 34a, 34b are also in contact with the radial flanges 72a, 72b. As an alternative, an axial clearance (not shown) may be provided between the outer radial faces 38a, 38b and the radial flanges 72a, 72b.

In this example, the half-ring 3a defines an annular close space 39a delimited by the outer axial portion 31a, the radial portion 32a, the toroidal portion 33a and the inner axial portion 34a and, adjacent to these portions, the radial flange 72a of the first part 7a of the housing 7. A similar closed space 39b is defined between the half-ring 3b and the second part 7b of the housing 7. A lubricant, such as grease or oil, and/or electronic elements, such as a temperature sensor or a vibration sensor, and/or magnetic elements, such as a permanent magnet, may be located.

The outer axial cylindrical portion 71b is fixed to the inner axial cylindrical portion 71a by means of welding, brazing, glue, or any other fixation element not shown on the annexed figures.

According to the invention, the second part 7b of the housing 7 comprises a projected portion 9 which extends radially from the outer axial cylindrical portion 71b in the direction opposite to the rolling elements 4. The rolling bearing is pushed into a bore 10a of an external member 10. The outer surface of the outer axial cylindrical portion 71b is in contact with the inner surface of the bore 10a in order to position radially the rolling bearing 1. The projected portion 9 is in abutment against an outer radial face 10b of said external member 10 in order to position axially the rolling bearing 1. The projected portion 9 may be attached to the member by means of welding, brazing, glue, or any other fixation means.

In the embodiment of FIG. 1a, the projected portion 9 is a radial flange having an internal radial surface 9a, an external radial surface 9b and an outer axial face 9c which form the outer edge of the projected portion 9. The internal radial surface 9a is in contact with the outer radial surface 10b of the external member 10. Such a contact surface permits to precisely position the rolling bearing 1 on its supporting member 10.

The only difference of FIG. 1a with the embodiment of FIG. 1b, in which identical elements bear the same references, is the axial position of the projected portion 9, more particularly of the surface 9a in contact with the outer radial surface 10b of the member 10. The outer axial cylindrical portion 71b has a shorter axial length and the axial position of the projected portion 9 is moved away from the radial flange 72a of the first part 7a of the housing 7. Therefore the axial position of the rolling bearing 1 is shifted in the direction opposite to the bore 10a of the external member 10. Thanks to the possibility to define the axial position of the projected portion 9 at any location, the axial position of the rolling bearing 1 can be adjusted depending on the application and the complete assembly without being a design constraint anymore.

Advantageously, the axial position f of the projected portion 9, which is defined between the outer radial surface of the radial flange 72a of the first part 7a of the housing 7 and the contact radial surface 9a of the projected portion in contact with the outer radial surface 10b of the external member 10, is comprised between 0 and 50% of the total axial length g of the rolling bearing 1, which is defined between the two outer radial surfaces of the radial flanges 72a and 72b of the housing 7. Then the outer axial cylindrical portion 71b covers the inner axial cylindrical portion 71a on a length enough for ensuring a good radial maintain of the assembly.

The only difference of FIG. 1a with the embodiment of FIG. 1c, in which identical elements bear the same references, is the axial position of the rolling bearing 1 on the external member 10. The two distinct parts 7a, 7b of the housing 7 are inverted, that is to say the radial flange 72b is now in contact with the half-ring 3a and the radial flange 72a with the half-ring 3b. The inner axial cylindrical portion 71a still covers the axial portions 31a and 31b and the outer axial cylindrical portion 71b still covers the inner axial portion 71a. The projected portion 9 is now in contact with the outer radial surface 10a of the external member by the radial surface 9b. A part of the outer surface of the inner axial cylindrical portion 71a is now in contact with the inner surface of the bore 10a.

Thanks to the possibility to invert the two distinct parts 7a, 7b of the housing 7, one can position the rolling bearing 1 in any desired axial position even if some limitations are imposed on the ratio f/g as explained before.

In the embodiments of FIG. 1a to 1c, the rolling bearing 1 may be in abutment against a second member (not represented) being in radial contact with the projected portion 9, the said second member facing the first member 10. Then the two radial surfaces 9a and 9b that define an axial distance e are each in contact with a radial surface of one external member. The axial distance between the two members is limited by the thickness of the projected portion 9, which is the thickness of the metal sheet forming the housing second part. This could be a drawback if a higher axial distance is needed between the two external members.

The embodiment illustrated in FIG. 2, in which identical elements bear the same references, differs from the embodiments of FIGS. 1a to 1c in that the projected portion 9 has a half-circle shape. The projected portion 9 is outwardly curved from the outer axial cylindrical portion 71b. The projected portion is provided with a radial surface 91a which is the outer edge of the projected portion 9. In the illustrated example, the radial surface 91a is in contact with the outer radial surface 10b of the external member 10. A closed space 11 is defined between the projected portion 9 and the member 10. A second member (not represented) may be in contact with the projected portion 9 by a radial contact surface 91b at the extremity of the curvature.

The axial length e between the two radial surfaces 91a and 91b may be adjusted by increasing the radius of curvature of the half-circle shape which overcomes the aforementioned drawback.

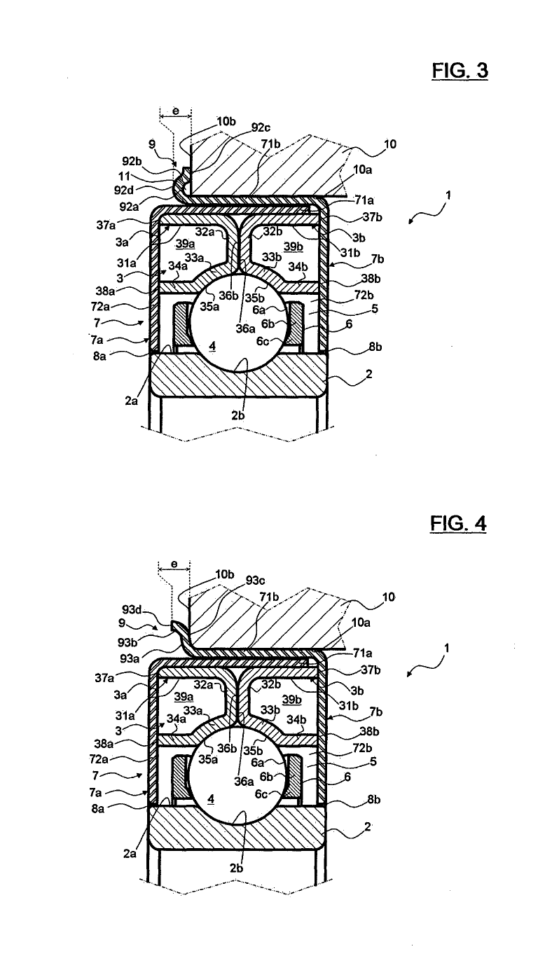

The embodiment illustrated in FIG. 3, in which identical elements bear the same references, differs from the embodiments of the previous Figures in that the projected portion 9 has an axially inwardly curved portion 92a which is extending from the outer cylindrical portion 71b, and a radial portion 92b which is extending radially outwards from the said curved portion 92a. In the illustrated example, a radial surface 92c of the radial portion 92b is in contact with the outer radial surface 10b of the external member 10. A closed space 11 is defined between the projected portion 9 and the member 10. A second member (not represented) may be in contact with the projected portion 9 by a radial contact surface 92d at the extremity of the curvature.

The axial length e between the two radial surfaces 92c and 92d may be adjusted by increasing the radius of curvature of the half-circle shape and/or the position of the radial portion 92b which overcomes the aforementioned drawback.

The embodiment illustrated in FIG. 4, in which identical elements bear the same references, differs from the embodiments of the previous Figures in that the projected portion 9 has a radial portion 93a which is extending radially outwards from the outer cylindrical portion 71b, and an axially outwardly curved portion 93b which is extending from the said radial portion 93a. In the illustrated example, a radial surface 93c of the radial portion 93b is in contact with the outer radial surface 10b of the external member 10. A second member (not represented) may be in contact with the projected portion 9 by a radial contact surface 93d which is an outer edge of the projected portion 9.

The axial length e between the two radial surfaces 93c and 93d may be adjusted by increasing the radius of curvature of the half-circle shape.

The method of manufacturing and installing an assembly comprising such types of rolling bearing will now be described. One of the separate parts 3a of the outer ring 3 is inserted in a first part 7a of the housing 7. Then the inner ring 2 and the rolling elements 4 are installed in the first part 7a of the housing 7. The other separate part 3b of the outer ring 3 is inserted in the first part 7a of the housing 7. In a final manufacturing step of the rolling bearing 1, the second part 7b of the housing 7 is installed such as the outer axial cylindrical portion 71b surrounds the inner axial cylindrical portion 71a of the first part 7a and the said second part 7b is fixed to the first part 7a. The rolling bearing 1 is installed in the bore 10a of the external member 10 and the projected portion 9 of the second part 7b of the housing 7 is positioned in abutment against the outer radial surface 10b of the member 10. Finally the projected portion 9 of is fixed on the member 10.

Although the present invention has been illustrated using single-row ball bearings, it will be understood that the invention can be applied without major modification to bearings using rolling elements that are not balls and/or that have several rows of rolling elements. Alternatively, the inner ring could comprise two half rings and be surrounded by a housing having two distinct parts as described above with or without a projected portion.

1. A rolling bearing comprising:
an inner ring;
an outer ring; and
at least one row of rolling elements in a rolling chamber defined between the rings;
an annular housing surrounding at least one of the rings comprising at least two separate parts, the housing comprising two distinct parts for retaining the separate parts of the ring,
wherein the first part is provided with an inner axial cylindrical portion for retaining radially the at least two parts of said ring, and
wherein the second part is provided with an outer axial cylindrical portion surrounding said inner axial cylindrical portion, and a projected portion extending radially outwards.

2. The rolling bearing according to claim 1, wherein each of the first part of the housing and the second part of the housing comprises a radial flange extending radially from the axial cylindrical portion towards the other ring.

3. The rolling bearing according to claim 1, wherein the projected portion is a radial flange provided with two radial surfaces and an outer axial face.

4. The rolling bearing according to claim 1, wherein the projected portion is provided with at least one curved portion.

5. The rolling bearing according to claim 4, wherein the projected portion has a half-circle shape.

6. The rolling bearing according to claim 4, wherein the projected portion has an axially inwardly curved portion which is extending from the outer cylindrical portion, and a radial portion which is extending radially outwards from the curved portion.

7. The rolling bearing according to claim 4, wherein the projected portion has a radial portion which is extending radially outwards from the outer cylindrical portion, and an axially outwardly curved portion which is extending from the said radial portion (93a).

8. The rolling bearing according to claim 1, wherein the projected portion is provided with a radial portion extending radially outwards from the outer cylindrical portion, and an axial portion extending one of axially inwards or axially outwards from the radial portion.

9. An assembly comprising at least one external member against a rolling bearing, the rolling bearing including:
an inner ring;
an outer ring; and
at least one row of rolling elements in a rolling chamber defined between the rings;
an annular housing surrounding at least one of the rings comprising at least two separate parts, the housing comprising two distinct parts for retaining the separate parts of the ring,
wherein the first part is provided with an inner axial cylindrical portion for retaining radially the at least two parts of said ring, and
wherein the second part is provided with an outer axial cylindrical portion surrounding said inner axial cylindrical portion, and a projected portion extending radially outwards.

10. The rolling bearing according to claim 8, wherein the axial position of the surface contact between the projected portion and the external member is between 0 and 50% of the total axial length of the rolling bearing.

11. The rolling bearing according to claim 1, wherein the projected portion is fixed on the external member by a fixing element.

12. A method of manufacturing and installing an assembly, comprising at least one external member against a rolling bearing, the rolling bearing including:
an inner ring;
an outer ring; and
at least one row of rolling elements in a rolling chamber defined between the rings;
an annular housing surrounding at least one of the rings comprising at least two separate parts, the housing comprising two distinct parts for retaining the separate parts of the ring,
wherein the first part is provided with an inner axial cylindrical portion for retaining radially the at least two parts of said ring, and
wherein the second part is provided with an outer axial cylindrical portion surrounding said inner axial cylindrical portion, and a projected portion extending radially outwards.
the method comprising the steps of:
inserting one of the separate parts of one ring in a first part of the housing comprising a radial flange and an inner cylindrical portion,
inserting the other ring and the rolling elements in the first part of the housing,
inserting the other separate part (3b) of the said ring in the first part of the housing,
fixing the second part of the housing comprising a radial flange (72b) and an outer cylindrical portion so as to surround said inner axial cylindrical portion,
inserting the rolling bearing in a bore of an external member, and
positioning the projected portion of the housing second part in abutment against the external member.

13. Method of manufacturing and installing an assembly according to claim 12, comprising an additional step of:
fixing the projected portion of the housing second part on the external member.
